(19) United States
(12) Patent Application Publication
(10) Pub. No.: US 2010/0313963 A1
(43) Pub. Date: Dec. 16, 2010

(54) GAS MIXER AND SAMPLER SYSTEM FOR A CONTROLLED ATMOSPHERE LABORATORY CHAMBER

(75) Inventor: Andrew Skinn, Bridgend (GB)

Correspondence Address: NIXON & VANDERHYE, PC, 901 NORTH GLEBE ROAD, 11TH FLOOR, ARLINGTON, VA, 22203, US

(73) Assignee: RUSKINN LIFE SCIENCES LIMITED, Bridgend (GB)

(21) Appl. No.: 12/734,604

(22) PCT Filed: Nov. 12, 2008
(86) PCT No.: PCT/GB2008/003803

§ 371 Date: Aug. 30, 2010

(30) Foreign Application Priority Data
Nov. 13, 2007 (GB) 0722226.8

(51) Int. Cl. B01F 5/04

(52) U.S. Cl. 137/3; 137/897

(57) ABSTRACT

A gas mixer and sampler system (2) for a controlled atmosphere laboratory chamber (4), the mixer and sampler system has a sampler remote from the chamber and a gas supply arrangement, including a mixer (14) remote from the chamber. The sampler consists of a gas sensor arrangement (5) for sensing a first and a second gas. A processor output from the gas sensors to determine the relative concentrations of the first and second gases, and determine proportions and flow rate for gases to be supplied to the chamber to meet a determined profile. The mixer and sampler are provided externally of the chamber at a location spaced from the chamber.

The present invention relates to a gas mixer and sampler system for a controlled atmosphere laboratory chamber, particularly but not limited to such a system suitable for use in laboratory systems for use in in-vitro fertilisation and related procedures.

IVF treatment has gained popularity over the last twenty five years providing the opportunity for infertile couples to improve chances of reproduction. The female is treated with hormones such that a large number of unfertilised eggs can be extracted and taken to a laboratory where they are treated under carefully controlled conditions.

The unfertilised eggs are washed, sorted and fertilised and then transferred to an incubating environment which is arranged to as closely as possible resemble the conditions inside the body. For this reason, careful control is made of the temperature and gas concentrations. Once the fertilised eggs have reached embryonic stage, the best embryos are selected and implanted into the female.

As the conditions under which the embryo forms are critical and must closely resemble those found in the body, an apparatus must be provided that achieves and constantly maintains such a suitable environment in terms of temperature, humidity and concentration of mixed gasses. It is known that a high proportion of IVF failures are due to the effects of the environment, which is typically controlled in an active chamber. An example of such a chamber is disclosed in WO-A-2005/040330.

Other prior art arrangements for use in providing a controlled atmosphere laboratory environment are disclosed in, for example EP-A-0967268, EP-A-0154536, U.S. Pat. No. 4,336,329, GB-A-2138949 and U.S. Pat. No. 3,929,584.

An improved arrangement has now been devised.

According to a first aspect, the present invention provides a gas mixer and sampler system for a controlled atmosphere laboratory chamber, the mixer and sampler system comprising:
an inlet for receiving the atmosphere gas drawn from the chamber;
a sampler arrangement remote from the chamber and comprising a first gas sensor arrangement for sensing a first gas and a second gas sensor arrangement for sensing a second gas;
a processor arrangement arranged to process output from the gas sensors to determine the relative concentrations of the first and second gases;
a gas supply arrangement, including a mixer remote from the chamber to which the respective first and second gases are delivered in proportions and at flow rates as determined by the processor;
a gas delivery line for delivering premixed gas, premixed at the mixer, to the chamber;
wherein the mixer and sampler arrangement are provided externally of the chamber at a location spaced from the chamber.

The arrangement is therefore preferably such that both the sampling is conducted remotely from the chamber and premixing of gases for delivery to the chamber is conducted remotely from the chamber.

The provision of a separate sampler discrete and separate from the chamber ensures that undesirable environmental interaction between the gas sensor arrangement and atmosphere in the chamber is prevented, thereby providing an environment having reduced fluctuation in gas concentration and interference.

The chamber is beneficially remote from the sampler arrangement. This enables sampling of the gas in the system avoiding the problems associated with known arrangements whereby monitoring of the gas in the chamber causes RF or other interference.

The mixer is also remote from the chamber ensuring that the gases are delivered premixed to the chamber. It is this novel and beneficial characteristic that provides particular advantage, particularly where the system is provided as a mixer and sampler unit in which the components can be held in relative close physical proximity but spaced from the chamber and connected simply by fluid connections to the chamber. The processor can be included in the combined unit.

It is preferred that a gas return line is provided to return the gas drawn from the chamber back to the chamber, following passage through the sampler arrangement. A pump is beneficially provided to pump gas between the chamber and the sampler arrangement.

Beneficially, the processor uses the values of the first and second gas concentrations to derive a value for a further gas in the sampled atmosphere. Beneficially the processor operates the gas supply arrangement to mix and supply gasses according to a demand profile or regime programmed into the system. The system preferably includes input means for inputting a plurality of different atmosphere profiles or regimes and the processor operates to control operation of the gas supply arrangement to mix and supply the gases to the chamber to meet the demand atmosphere profile or regime input into the system.

In one realisation of the invention, the first and second gases comprise carbon dioxide and oxygen. Beneficially, in this realisation the atmosphere of the chamber also includes nitrogen. In this realisation, the sampler arrangement preferably comprises an oxygen sensor device and a carbon dioxide sensor device. In one embodiment it may be preferred for the oxygen sensor device to be situated in a sampling plenum. In one embodiment it may be preferred for the oxygen sensor device and the carbon dioxide sensor device to be provided flow wise, in series.

It is preferred that the gas supply arrangement comprises supplies of the first and second gas to be mixed at the mixer. The gas supply arrangement also beneficially comprises a third gas to be mixed at the mixer.

It is preferred that the system includes a de-humidifier arrangement.

According to a second aspect, the present invention provides a method of establishing a controlled gaseous atmosphere in a chamber of laboratory apparatus, the method comprising:
at a sampler arrangement remote from the chamber, sampling atmosphere gas drawn from the chamber by means of passing via a first gas sensor arrangement for sensing a first gas and a second gas;
processing output from the gas sensors to determine the relative concentrations of the first and second gases in the gas atmosphere drawn from the chamber;
at a mixer remote from the chamber mixing gases supplied from a supply system according to a demand profile generated by the processor and delivering the premixed gases via a delivery line to the chamber;
wherein the mixer and sampler arrangement are provided externally of the chamber at a location spaced from the chamber such that the sampling of both gases is conducted remotely from the chamber and premixing of gases for delivery to the chamber is also conducted remotely from the chamber.

According to a further aspect, the invention provides a laboratory system comprising:
a chamber in which a controlled atmosphere is required to be maintained;
an inlet for receiving the atmosphere gas drawn from the chamber;
a sampler arrangement remote from the chamber and comprising a first gas sensor arrangement for sensing a first gas and a second gas sensor arrangement for sensing a second gas;
a processor arrangement arranged to process output from the gas sensors to determine the relative concentrations of the first and second gases;
a gas supply arrangement, including a mixer remote from the chamber to which the respective first and second gases are delivered in proportions and at flow rates as determined by the processor;
a gas delivery line for delivering premixed gas, premixed at the mixer, to the chamber;
wherein the mixer and sampler arrangement are provided externally of the chamber at a location spaced from the chamber.

It is preferred that a gas pressure control valve is provided for the chamber, arranged to adjust the gas pressure in the chamber.

According to a further aspect, the invention provides a gas mixer and sampler system for a controlled atmosphere laboratory chamber, the mixer and sampler system comprising:
an inlet for receiving the atmosphere gas drawn from the chamber;
a sampler arrangement comprising an oxygen sensor arrangement for sensing oxygen;
a processor arrangement arranged to process output from the oxygen sensor to determine the relative concentrations of oxygen in the sampled gas;
a gas supply arrangement, including a gas mixer:
wherein the system is operable in a calibration mode in which the chamber is arranged to be isolated from the sampler arrangement and;
i) exterior air is drawn via the oxygen sensor; and/or
ii) non-oxygen gas is drawn from the gas supply arrangement via the oxygen sensor
in order to enable calibration of the oxygen sensor.

Beneficially, the system is operable to both draw air via the oxygen sensor and draw a non-oxygen gas supply from the gas supply arrangement in order to calibrate the oxygen sensor at a plurality of know values of oxygen concentration.

The present invention will now be described by way of example only with reference to the accompanying drawings in which:

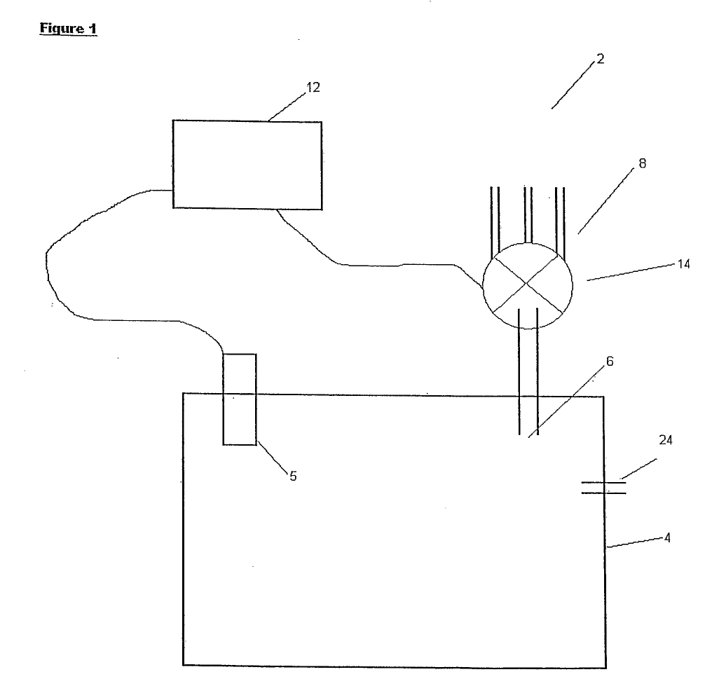

FIG. 1 is a schematic representation of a system, that falls outside the scope of the invention, for providing controlled gaseous atmosphere;

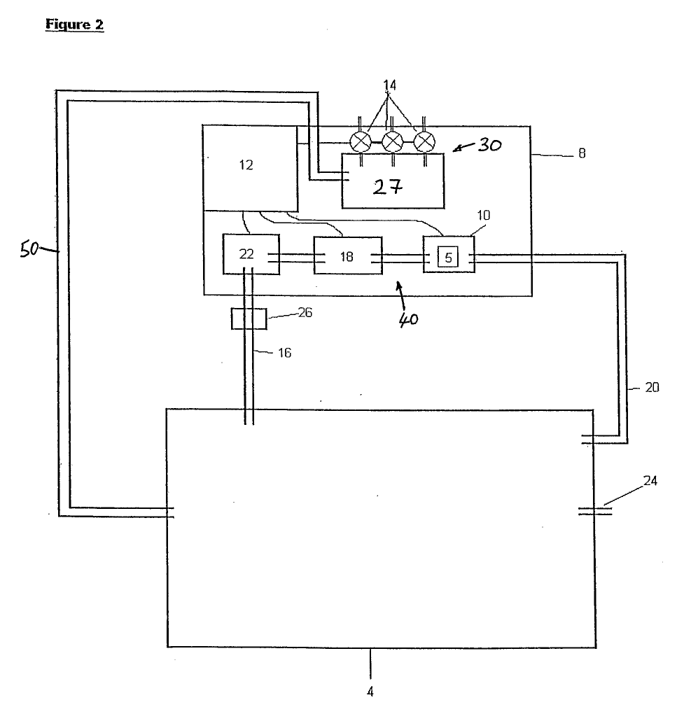

FIG. 2 is a schematic representation of a system for providing a controlled gaseous environment according to an exemplary embodiment of the present invention.

Referring to FIG. 1, there is schematically represented a work station providing a gas controlled environment suitable for use in IVF. The arrangement of FIG. 1 may be used to provide a chamber environment having a controlled chamber atmosphere, but does not exhibit the benefit of the present invention. The system 2 generally comprises a chamber 4 in which fertilisation is carried out, and further incubation of the fertilised egg may be achieved. The process generally comprises the steps of washing and counting of the eggs, examination and fertilisation. The chamber 4 is maintained at the desired temperature and has an oxygen sensor 6 therein which measures the concentration of oxygen in the chamber 4. The chamber 4 comprises an inlet 6 through which gas is received from a multi gas supply 8. The multi gas supply 8 is controlled via a microprocessor control system 12. The multi gas supply 8 further comprises a gas flow regulator 14 which is controlled by the control system 12. The gas input lines into the regulator 14 are in this instance carbon dioxide, nitrogen and oxygen. Signals are received from the oxygen sensor 5 thereby sending the relevant information to cause the correct volume of oxygen to be injected into the chamber 4 to re-address any imbalance. The volume of carbon dioxide gas enabled to enter the chamber 4 via the regulator 14 is calculated through the relative proportion of oxygen in the chamber 4. The volume of nitrogen also injected into the chamber 4 is also calculated in this way by the microprocessor control system 12. In this manner a controlled environment within the chamber 4 is provided.

A problem with the arrangement of FIG. 1 is the lack of accurate control of the concentration of gases and additionally the action that the oxygen sensor and its control and power supply system has on the environment in the chamber 4. The oxygen sensor, coupled to the control system is enabled through an electric signal which causes interference. Calibration of the oxygen sensor also requires removal from the chamber and as such possible loss of atmosphere may occur during calibration.

FIG. 2 shows a chamber 4 which may be used as a laboratory apparatus particularly suited but not exclusively suited for use in the IVF process. The chamber 4 may particularly be used for the washing and counting of the eggs and subsequent fertilisation. The chamber 4 may be also used as an incubator in which these cultures are kept in an environment in which the gas and temperature levels are controlled to resemble the conditions that would be present inside the body.

The system comprises a combined gas mixer and sampler unit 8, including a sampler bank 40 having flow-wise in series an oxygen sensor 5 (provided in a plenum sampling chamber 10) and a carbon dioxide sensor 18. An inlet line 20 directs atmosphere gas from the chamber 4 to the sampling bank and a return line 16 directs the sampled atmosphere back to the chamber 4. A diaphragm pump 22 controlled by the processor control system 12 is provided to effect the recirculation of the atmosphere gas.

The mixer arrangement 30 of the combined sampler/mixer unit 8 comprises a multi regulator system 14 which enables pressurised ‘top up’ or ‘balancing’ gases (oxygen carbon dioxide or nitrogen) to be supplied in the desired concentrations from a gas supply means located at a remote location (not shown) into a dedicated mixing chamber 27. The mixing chamber 27 is provided internally of the unit 8 and provides for mixing of the gases before being supplied into the premixed gas delivery line 50 for delivery into the chamber 4.

The regulator system 14 is connected electronically to the microprocessor control system 12 which calculates the required adjustment to the concentration of nitrogen, oxygen and/or carbon dioxide to be made. This calculation by the control system 12 is made based on the measured concentrations obtained from the oxygen sensor 5 and carbon dioxide sensor 18. The microprocessor control system uses the values of the oxygen and carbon dioxide concentrations to derive a value for nitrogen in the sampled atmosphere. The microprocessor control system may then operate the gas supply regulators 14 to mix and supply gasses according to a demand profile or regime programmed into the system. The unit 8 includes user input means for inputting a of different atmosphere profiles or regimes and the processor operates to control operation of the gas supply arrangement to mix and supply the gases to the chamber to meet the demand atmosphere profile or regime input into the system.

A pressure release valve 24 is beneficially also provided in the system enabling the pressure of the gas within the system to be maintained at a predetermined level. The pressure release valve 24 is located in the chamber 4 and may also be controlled by the microprocessor control system 12. A heating system is also preferably provided to maintain the temperature of the chamber 4 which is beneficial in maintaining the optimum environment mimicking that of the body. Again this may be controlled through the control system 12.

In use, gas from the chamber 4 is transferred to the sampling chamber 10 through gas line 20. A preferred minimum flow rate of 0.2 litres per minute and a maximum flow rate of 3.0 litres per minute is beneficially achieved which enables optimal analysis by the oxygen and carbon dioxide sensors. The gas flow passes over the oxygen sensor and preferably then subsequently through the carbon dioxide analyser 18. This is beneficial as it creates a single gas loop whereby the gas sample from chamber 4 is passed over the two sensors utilising the common pump 22.

Humidity will be removed from the gas via a “nafion tubing” or similar known device. The readings from the oxygen sensor 5 and carbon dioxide sensor 18 are then converted to electrical signals to provide a reading that is then communicated to the microprocessor control system, which may also be a programmable logic controller (PLC). The microprocessor controller 12 determines the relative percentages of respective gases as compared to the voltage to determine the atmosphere condition that is present in the chamber 4. The microprocessor controller 12 will then determine the gas percentage and compare it to the pre-selected value on the user operated interface (not shown). This may be a touch screen user interface in a preferred embodiment. The microprocessor controller 12 will then send a signal to the gas regulator system 14 in order to inject the relevant additional levels of carbon dioxide, oxygen and nitrogen. It will be appreciated that measurement of the two primary gases, i.e. oxygen and carbon dioxide, will enable the remaining gas concentration which is nitrogen to be calculated i.e. 100%- (O₂ level +CO₂ level)=N₂. It will be appreciated that user operation through the control of the touch screen will enable relevant conditions as required for the specific purpose to be achieved. For example, in some circumstances it is beneficial to operate at 0% oxygen levels.

The gas mixer 8 may also be retrofit to existing systems without the requirement to replace the corresponding chamber 4. The system may be also automatically calibrated. A suitable calibration level such as 20.9% and 0% conditions (oxygen) and 400 ppm carbon dioxide (dependent on the voltage sensitivity) may be selected corresponding to atmospheric gas concentration. Calibration can, however, be carried out at other levels and the present invention is not limited in this regard. The function “auto-calibrate” may be selected by the user on the user interface, in which the oxygen sensor can be automatically calibrated. In auto-calibrate mode, the chamber 4 is isolated and ‘ambient’ atmosphere (air) is draw from externally of the system via the action of the pump 22 and directed to flow over the oxygen sensor 5 and in turn through the carbon dioxide analyser. Unlike in normal use, the sampled air is vented to the atmosphere, and one or more valves (such as valve 26) are therefore provided to enable the calibration air to be introduced into the sampler bank 40 and then vent back to atmosphere. During the auto-calibrate routine, the microprocessor controller 12 will continue to monitor the gas sample until the corresponding voltage, as an example, 20.9% oxygen and 400 ppm carbon dioxide, is achieved. Once achieved, the atmosphere in the sampling system will then be changed to pure nitrogen via a connection with the regulator 14 (not shown) 14 and 0% oxygen calibration can be achieved. Thus, gas from the chamber 4 is prevented from entering the sampling zone temporarily until the calibration is complete and/or replacement of one or more components is achieved. In the event that calibration cannot be achieved, the PLC will offer a suitable message to the user in relaying the error in the system. This will normally be failure of the oxygen sensor and replacement of this component can be conducted quickly and easily. During calibration, the gas in the chamber 4 will be isolated and as such the auto-calibration routine can be carried out without affecting the conditions in the chamber 4.

There are significant advantages associated with the present invention. Specifically, analysis of both oxygen and carbon dioxide enables an accurately controlled environment to be achieved. Furthermore, the oxygen sensor does not cause interference in the chamber 4 nor heat the chamber in an uncontrolled manner providing a more effective environment for the necessary task. Also the mixing of the ‘balancing’ gases to be supplied to the chamber externally of the chamber (preferably in a discrete mixing chamber upstream of a supply line to the chamber) provides beneficial operation in that the gases are already intimately mixed before entering the chamber. The provision of sampler function and gas mixer function in a discrete stand alone unit located away from the working chamber also provides benefits. Additionally, an auto-calibration procedure can be followed ensuring careful control of the gas concentration in the system is maintained.

The present invention has been described by way of example only and it will be appreciated by a person skilled in the art that modifications and variations may be made without departing from the scope of protection afforded by the appended claims.

1. A gas mixer and sampler system for a controlled atmosphere laboratory chamber, the mixer and sampler system comprising:
an inlet for receiving the atmosphere gas drawn from the chamber;
a sampler arrangement remote from the chamber and comprising a first gas sensor arrangement for sensing a first gas and a second gas sensor arrangement for sensing a second gas;
a processor arrangement arranged to process output from the gas sensors to determine the relative concentrations of the first and second gases;
a gas supply arrangement, including a mixer remote from the chamber to which the respective first and second gases are delivered in proportions and/or at flow rates as determined by the processor;
a gas delivery line for delivering premixed gas, premixed at the mixer, to the chamber;
wherein the mixer and sampler arrangement are provided externally of the chamber at a location spaced from the chamber.

2. A system according to claim 1, wherein a gas return line is provided to return the gas drawn from the chamber back to the chamber.

3. A system according to claim 1, further comprising a pump to pump gas between the chamber and the sampler arrangement.

4. A system according to claim 1, wherein the processor uses the values of the first and second gas concentrations to derive a value for a further gas in the sampled atmosphere.

5. A system according to claim 1, wherein the first and second gases comprise carbon dioxide and oxygen.

6. A system according to claim 1, wherein the gas supply arrangement comprises supplies of the first and second gas to be mixed at the mixer.

7. A system according to claim 6, wherein the gas supply arrangement comprises a third gas to be mixed at the mixer.

8. A system according to claim 1 wherein the sampler arrangement comprises an oxygen sensor device and a carbon dioxide sensor device.

9. A system according to claim 8, wherein the oxygen sensor device is provided in a sampling plenum.

10. A system according to claim 8, wherein the oxygen sensor device and the carbon dioxide sensor device are provided flow wise in series.

11. A system according to claim 1 including a de-humidifier arrangement.

12. A system according to claim 1, which includes input means for inputting a plurality of different atmosphere regimes and the processor operates to control operation of the gas supply arrangement to mix and supply the gases to the chamber to meet the demand atmosphere regime input into the system.

13. A method of providing a controlled gaseous atmosphere in a chamber of laboratory apparatus, the method comprising:
at a sampler arrangement remote from the chamber, sampling atmosphere gas drawn from the chamber by means of passing via a first gas sensor arrangement for sensing a first gas and a second gas;
processing output from the gas sensors to, determine the relative concentrations of the first and second gases in the gas atmosphere drawn from the chamber;
at a mixer remote from the chamber mixing gases supplied from a supply system according to a demand profile generated by the processor and delivering the premixed gases via a delivery line to the chamber;
wherein the mixer and sampler arrangement are provided externally of the chamber at a location spaced from the chamber such that the sampling of both gases is conducted remotely from the chamber and premixing of gases for delivery to the chamber is also conducted remotely from the chamber.

14. A laboratory system comprising:
a chamber in which a controlled atmosphere is required to be maintained;
an inlet for receiving the atmosphere gas drawn from the chamber;
a sampler arrangement remote from the chamber and comprising a first gas sensor arrangement for sensing a first gas and a second gas sensor arrangement for sensing a second gas;
a processor arrangement arranged to process output from the gas sensors to determine the relative concentrations of the first and second gases;
a gas supply arrangement, including a mixer remote from the chamber to which the respective first and second gases are delivered in proportions and/or at flow rates as determined by the processor;
a gas delivery line for delivering premixed gas, premixed at the mixer, to the chamber;
wherein the mixer and sampler arrangement are provided externally of the chamber at a location spaced from the chamber.

15. A laboratory system according to claim 14, further comprising a gas pressure control valve for the chamber, arranged to adjust the gas pressure in the chamber.

16. A gas mixer and sampler system for a controlled atmosphere laboratory chamber, the mixer and sampler system comprising:
an inlet for receiving the atmosphere gas drawn from the chamber;
a sampler arrangement comprising an oxygen sensor arrangement for sensing oxygen;
a processor arrangement arranged to process output from the oxygen sensor to determine the relative concentrations of oxygen in the sampled gas;
a gas supply arrangement, including a gas mixer:
wherein the system is operable in a calibration mode in which the chamber is arranged to be isolated from the sampler arrangement and;
i) exterior air is drawn via the oxygen sensor; and/or
ii) non-oxygen gas is drawn from the gas supply arrangement via the oxygen sensor
in order to enable calibration of the oxygen sensor.
